(19) United States
(12) Patent Application Publication
(10) Pub. No.: US 2010/0092842 A1
(43) Pub. Date: Apr. 15, 2010

(54) DENSIFIED CERAMIC MATERIALS AND RELATED METHODS

(75) Inventors: Lars Rose, Vancouver (CA); Olivera Kesler, Toronto (CA); Alan Burgess, North Vancouver (CA); Zhaolin Tang, Vancouver (CA)

Correspondence Address: OYEN, WIGGS, GREEN & MUTALA LLP;480 - THE STATION, 601 WEST CORDOVA STREET, VANCOUVER, BC, V6B 1G1, CA

(73) Assignees: THE UNIVERSITY OF BRITISH COLUMBIA, Vancouver, BC (CA); NORTHWEST METTECH CORPORATION, North Vancouver, BC (CA)

(21) Appl. No.: 12/526,490

(22) PCT Filed: Feb. 8, 2008
(86) PCT No.: PCT/CA2008/000272

§ 371 Date: Sep. 9, 2009

Related U.S. Application Data
(60) Provisional application No. 60/889,209, filed on Feb. 9, 2007.

(51) Int. Cl. H01M 8/08; B05D 1/08

(52) U.S. Cl. 429/46; 427/115; 427/448; 427/447

(57) ABSTRACT

A method for making a densified ceramic layer comprises plasma spraying a layer of the ceramic onto a substrate; spin-coating the plasma-sprayed layer with a sol, and firing the spin-coated ceramic layer. The method may be applied in producing layers of yttria stabilized zirconia (YSZ) having application as electrolyte layers for solid oxide fuel cells or thermal barrier coatings, for example. The firing may be performed at a relatively low temperature such as 650° C. or even below. A method for enhancing electrochemical properties of an interface involving a layer of YSZ or other ceramic comprises spin-coating or otherwise impregnating the layer with a sol and heating the spin-coated layer.

### CROSS-REFERENCE TO RELATED APPLICATION

This application claims priority from U.S. application No. 60/889209 filed on 9 Feb. 2007 and entitled DENSIFIED CERAMIC MATERIALS AND METHODS FOR MAKING SAME. For purposes of the United States of America, this application claims the benefit under 35 U.S.C. §119 of U.S. application No. 60/889209 filed on 9 Feb. 2007 and entitled DENSIFIED CERAMIC MATERIALS AND METHODS FOR MAKING SAME which is hereby incorporated herein by reference.

### TECHNICAL FIELD

The invention relates to ceramic materials and in particular to the making of dense layers of ceramic materials. Embodiments of the invention may be used to make dense layers of ceramic materials such as yttria stabilized zirconia (YSZ). Other embodiments may be applied to make layers of other ceramics. Such layers have application, inter alia, as electrodes for solid oxide fuel cells.

### BACKGROUND

Fuel cells convert chemical energy of suitable fuels into electrical energy without combustion and with little or no emission of pollutants. Fuel cells may be produced on a wide variety of scales in terms of both energy output and physical dimensions. Fuel cells can be used to generate electrical power in any of a wide variety of applications including powering vehicles, auxiliary power units (APUs) and cogeneration of power and heat for residential and business uses.

Solid Oxide Fuel Cells (SOFCs) are solid-state fuel cells that typically operate at high temperatures. SOFCs can be highly efficient. One application of SOFCs is in stationary power generation, including both large-scale central power generation, and distributed generation in individual homes and businesses. High operation temperatures provide fast reaction kinetics and high ionic conductivity, and therefore high efficiency, but also create technological challenges related to materials design and cell processing.

An SOFC includes an electrolyte layer that conducts ions but is not electronically conductive. The electrolyte layer separates cathode and anode sides of the fuel cell. It is important that the electrolyte not be penetrated by pores that could permit mixing of cathode and anode reactant gases. Mixing of cathode and anode reactant gases can lead to internal losses and an overall decrease in efficiency. It is desirable that the electrolyte layer be thin to achieve high efficiency.

Yttria stabilized zirconia (YSZ) is commonly used as an electrolyte material for Solid Oxide Fuel Cells (SOFCs), due to its pure ionic conductivity and chemical stability. Standard electrolyte fabrication techniques for solid oxide fuel cell electrolytes involve wet ceramic techniques such as tape-casting or screen printing. Such techniques typically require high-temperature sintering (typically at temperatures above 1300° C.). The complex multi-step processing procedures are time consuming. Providing infrastructure to support manufacturing of SOFCs by such procedures can involve significant capital costs.

Plasma spraying is a technique that can be applied to deposit layers of a wide range of materials on suitable substrates. However, it is difficult to produce plasma sprayed layers that are both thin (<about 10 μm or 20 μm) and completely dense. The density of plasma sprayed layers may be improved by plasma spraying onto a substrate in a vacuum. However, maintaining vacuum conditions during plasma spraying increases capital and operating costs and erodes the cost benefit obtained by plasma spraying.

Atmospheric plasma spraying (APS) is performed in air. No special atmospheric conditions are required for APS. Consequently, APS is less expensive both in capital and operation cost compared to vacuum plasma spraying. However, when the hot high velocity plasma jet enters the static and relatively cold atmosphere near the substrate, the laminar jet flow experiences turbulent shear due to the velocity differences of the jet and the surrounding atmosphere, thus potentially introducing additional porosity into the coatings compared to that normally obtained by vacuum plasma spraying.

Typical plasma-sprayed ceramic YSZ coatings have porosities ranging from 5% to 15%. Plasma spraying has been proposed for making YSZ coatings for thermal barrier applications. In thermal barrier coatings it is desirable to have relatively high porosity (e.g. porosities of 5% -15%). YSZ thermal barrier coatings (TBCs) may be applied in applications in which it is desirable to provide a large thermal gradient over a YSZ coating only a few hundred micrometers in thickness. Formation of such a thermal gradient is facilitated by the use of porous YSZ coatings, since the thermal conductivity of the coatings decreases as porosity increases.

Various methods have been proposed to improve the density of plasma-sprayed coatings. These include:
S. Ahmaniemi, P. Vuoristo, and T. Mantyla, Improved sealing treatments for thick thermal barrier coatings, Surf. Coat. Technol., 151 -152, 2002, p 412-417 describes acidic phosphate solution sealing;
B. R. Marple, J. Voyer, and P. Bechard, Sol infiltration and heat treatment of alumina-chromia plasma-sprayed coatings, J. Europ. Ceram. Soc., 21, 2001, p 861-868 describes a method of densification of certain materials that uses silica sols,
X. J. Ning, C. X. Li, C. J. Li, and G. J. Yang, Modification of microstructure and electrical conductivity of plasma-sprayed YSZ deposit through post-densification process, Mater. Sci. Eng. A, 428, 2006, p 98-105 and C. J. Li, X. J. Ning, C. X. Li, Effect of densification processes on the properties of plasma-sprayed YSZ electrolyte coatings for solid oxide fuel cells, Surf. Coat. Technol., 190, 2005, p 60-64 describe densification of YSZ deposits by nitrate decomposition;
C. Viazzi, J. P. Bonino, and F. Ansart, Synthesis by sol-gel route and characterization of Yttria Stabilized Zirconia coatings for thermal barrier applications, Surf. Coat. Technol., 2006, in press describes densification by sol immersion;
P. Bianchi, F. Cernuschi, L. Lorenzoni, S. Ahmaniemi, M. Vippola, P.

Vuoristo, and T. Mäntylä, Thermophysical and microstructural characterization of modified thick yttria stabilized zirconia thermal barrier coatings, in: J. Lecomte-Beckers, M. Carton, F. Schubert, P. Ennis (eds.), Proc. 7th Liege Conf. Mater. Adv. Pow. Eng., Energy Technol., 21, 2002, p 449-463 describes the use of laser glazing for densification;
S. Ahmaniemi, P. Vuoristo, T. Mantyla, C. Gualco, A. Bonadei, R. Di Maggio, Surf. Coat. Technol., 190 (2005) 378-387 describe drop coating of ceria-doped zirconia sols for sealing ; and
K. A. Khor, L. Yu, S. H. Chan, and X. J. Chen, Densification of plasma sprayed YSZ electrolytes by spark plasma sintering (SPS), J. Eur. Cer. Soc., 23, 2003, p 15-1863 describes densification by spark plasma sintering.

There remains a need for cost-effective ways to make dense layers of ceramics. There remains a particular need for such ways to make thin dense ceramic layers suitable for use as electrolytes in SOFCs.

### SUMMARY OF THE INVENTION

One aspect of the invention provides a method for making layers of ceramic materials. The methods comprise plasma spraying a layer of the ceramic onto a substrate; spin-coating the plasma-sprayed layer with a sol; and, firing the spin-coated ceramic layer. The ceramic material may comprise yttria stabilized zirconia (YSZ), rare-earth doped ceria (RDC), alumina-stabilized zirconia (ASZ) or other ceramic materials suitable for the intended application. RDCs include samaria-doped ceria (SDC), gadolinia-doped ceria (GDC), and ceria doped with other rare-earth elements or combinations of rare-earth elements. In some embodiments, the ceramic layer is an electrolyte layer for a solid oxide fuel cell. The plasma spraying may comprise atmospheric plasma spraying. In some embodiments the firing is performed in situ during the operation (or preparation for operation) of a cell incorporating a ceramic layer.

Another aspect of the invention provides a method for enhancing the electrochemical performance of a device that includes a ceramic layer. The method may be applied to enhance the electrochemical properties of an interface between a ceramic or cermet layer and another layer. For example, the method may be applied to enhance the electrochemical properties of an interface between an electrolyte layer and an electrode layer in a solid oxide fuel cell. The method comprises applying to a solid layer by spin coating a sol having a material composition similar to that of the layer and subsequently firing the layer. The ceramic layer may comprise a layer that has been applied by plasma spraying or a layer that has been formed by a process other than plasma spraying. The ceramic layer may comprise a YSZ layer, RDC layer, or ASZ layer, for example.

Methods as described herein may be applied in various applications including making fuel cell electrolytes and other layers and thermal barrier layers. Materials as described herein may have various applications including applications as fuel cell electrolytes and thermal barrier coating structures.

Other aspects of the invention provide ceramic materials having enhanced properties and fuel cell structures and fuel cells which incorporate such materials. Materials according to the invention and materials made according to methods of the invention have a wide range of applications including application as:
components of fuel cells (especially SOFCs);
thermal barrier coatings;
densified surface-hardened materials for industrial applications; and,
the like.

Further aspects of the invention and features of specific embodiments of the invention are described below.

### BRIEF DESCRIPTION OF THE DRAWINGS

The accompanying drawings illustrate non-limiting embodiments of the invention.

FIG. 1 is a flow chart illustrating a method according to an embodiment of the invention.

FIG. 1A is a set of X-ray diffraction patterns for a YSZ coating taken at different temperatures.

FIG. 1B is plot showing thermogravimetric analysis (“TGA”) data for a YSZ coating.

FIG. 2 is a graph illustrating the permeability of ceramic layers to helium gas with and without spin coated layers.

FIGS. 2A to 2D are graphs illustrating the permeability of ceramic layers to helium gas with spin coated layers having various concentrations and compositions. FIG. 2E is a graph showing the effect of various numbers of spin-coated layers on helium gas permeability of a ceramic layer.

FIG. 3 is a schematic cross-section through a solid oxide fuel cell as used in experiments used to characterize the performance of electrolyte layers formed by an embodiment of the method of FIG. 1.

FIGS. 4A and 4B are electrochemical impedance spectra for test cells made without and with applying sol gel layers respectively.

FIG. 5 shows the magnitude of the impedance of test cells made without and with applying sol gel layers at various operating temperatures.

FIGS. 6A and 6B are graphs showing voltage as a function of current density and power density as a function of current density for test cells made without and with applying sol gel layers respectively. FIG. 6C is a graph showing open circuit voltage for test cells as a function of a number of spin-coated sol gel layers applied during preparation of the test cells.

FIG. 7 includes polarization curves at 800° C., 750° C., and 700° C. for the sol-gel-impregnated cell of FIG. 6B.

FIGS. 8A and 8B illustrate steps in an example method for making a fuel cell.

### DESCRIPTION

Throughout the following description, specific details are set forth in order to provide a more thorough understanding of the invention. However, the invention may be practiced without these particulars. In other instances, well known elements have not been shown or described in detail to avoid unnecessarily obscuring the invention. Accordingly, the specification and drawings are to be regarded in an illustrative, rather than a restrictive, sense.

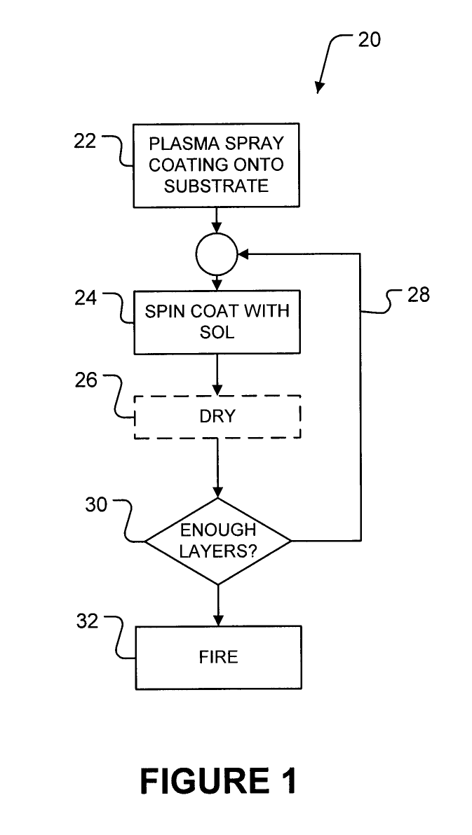

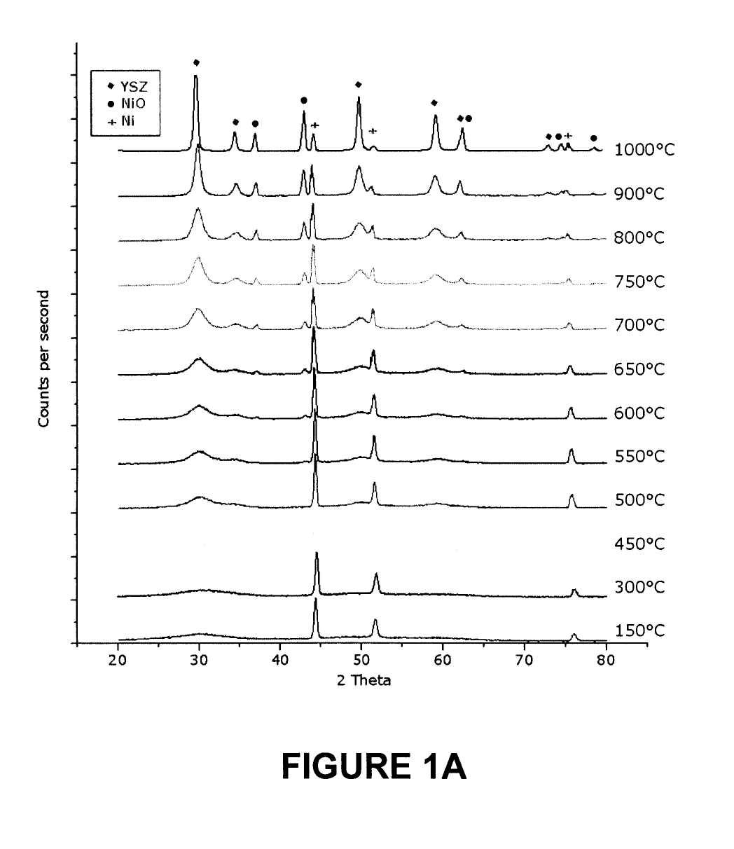

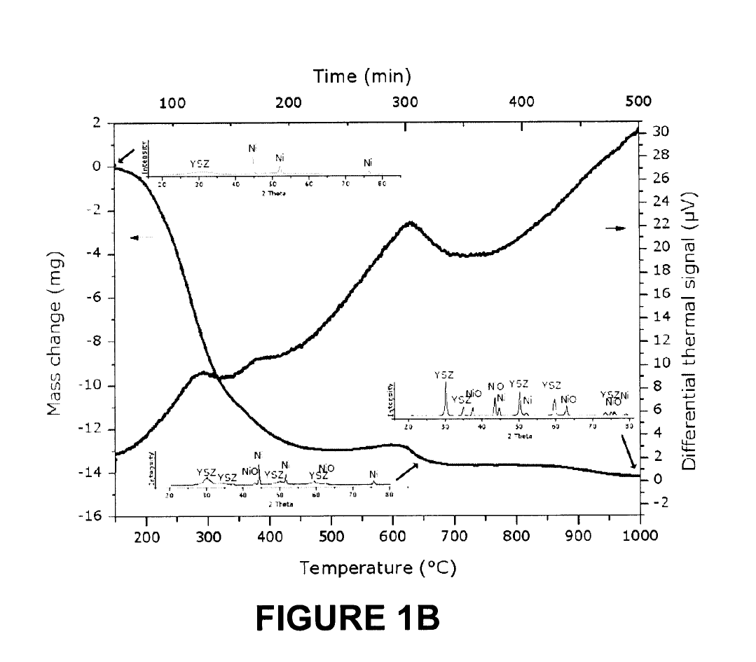

Thin dense layers of ceramic may be made by a process 20, as shown in FIG. 1 which involves spin-coating a plasma-sprayed ceramic coating with a sol gel to yield a ceramic coating having an increased density (and equivalently a decreased porosity).

In block 22, process 20 plasma sprays a layer of a ceramic onto a suitable substrate. The ceramic may, for example, comprise YSZ or another ceramic material such as:
ASZ,
calcia-stabilized zirconia,
magnesia-stabilized zirconia,
scandia-stabilized zirconia (ScSZ),
samaria-doped ceria (SDC, or equivalently, CSO for cerium-samarium oxide),
gadolinia-doped ceria, (GDC, or equivalently, CGO for cerium-gadolinium oxide),
lanthanum strontium gallium magnesium oxide (LSGM or, equivalently, LSGMO),
ceria doped with other rare-earth elements such as Y, La, Pr, Nd, or Pm, and
the like.

Such ceramics have a range of applications including applications in solid oxide fuel cells.

The plasma spraying may comprise, for example, vacuum plasma spraying or atmospheric plasma spraying. The as-sprayed ceramic layer typically is somewhat porous. In some embodiments, the as-plasma-sprayed ceramic layer has a porosity in excess of 5% or 10%. By carefully optimizing plasma spraying parameters it may be possible to produce as-sprayed ceramic layers having porosities of 5% or less.

In block 24 the ceramic layer is spin-coated with a sol. The sol may comprise particles having a composition that is the same as or similar to that of the ceramic layer.

The sol dries in block 26. Block 26 may involve heating the ceramic layer to assist in driving off a solvent from the sol. Drying each spin-coated layer of sol is considered advantageous as solvent can be removed more easily from thinner films.

As indicated by line 28 blocks 24 and 26 may optionally be repeated. In some embodiments, the number of spin-coated layers applied to the ceramic layer is few enough that the sol infiltrates pores in the ceramic layer without forming a distinct sol layer on top of the ceramic layer. In the demonstration embodiment discussed below, it was found that a distinct sol layer began to form after deposition of about 5 or 10 spin-coated sol layers. The number of sol layers that can be applied without forming a distinct layer on top of the ceramic layer will depend on factors such as the initial porosity of the ceramic layer and the characteristics of the sol. In other embodiments, a sufficient number of spin-coated layers is applied to form a distinct layer of the sol. The processing time can be reduced by applying fewer spin-coated layers.

After block 30 determines that enough layers of sol have been spin coated onto the ceramic layer, the layer is fired in block 32. Firing may be performed at a temperature that is lower than the temperatures commonly employed in making YSZ layers by wet ceramic processes. For example, in some embodiments the firing temperature in block 32 is less than 800° C. (less than 750° C. or 700° C. or 300° C. in some embodiments).

Because the firing in block 32 can occur at a relatively low temperature, the substrate may comprise materials that would be unacceptably degraded at higher sintering temperatures. For example, the substrate may incorporate metal components or layers.

### EXAMPLE 1

In a demonstration embodiment of the invention, NiO-YSZ substrates were produced by tape casting NiO-YSZ anode supports on a mylar sheet. A pore former was included in the NiO-YSZ anode supports. The substrates were produced from a slurry. A slurry was produced by mixing and ball milling the slurry mixture components listed in Table 1.

TABLE 1
Components of NiO-YSZ anode substrates.

| Chemical (Available From) | Purpose | Amount [g] |
|---|---|---|
| Ethanol (Fisher Scientific) | solvent | 200 |
| Toluene (Fisher, ACS grade) | solvent | 266 |
| Z-3 Fish Oil (Miller Tape Casting) | dispersant | 17 |
| YSZ (Tosoh, TZ8Y) | ionically- | 404 |
| | conducting phase | |
| green NiO (Inco, Grade F) | electronically- | 507 |
| | conducting phase | |
| | (after reduction) | |
| Carbon Black | pore former | 90 |
| (Cancarb, N991 ultra pure) | | |
| Polyvinylbutyral (Miller Tape Casting) | binder | 83 |
| Butyl Benzyl Phthalate S-160 | plasticiser | 116 |
| (Miller Tape Casting) | | |

The ethanol, toluene, and fish oil were ball milled for over 15 hours before adding the powders. The full mixture was then ball milled for 24 hours. Prior to tape casting a 1.2 mm thick tape in a class 1000 clean room, the slurry was degassed in vacuum for 30 minutes. The resulting tape was dried at room temperature for 72 hours, followed by 12 hours of drying at 60° C. Round one-inch diameter substrates approximately 1 mm thick were made for receiving plasma-sprayed YSZ coatings by cutting circles from the tape (allowing for shrinkage during firing). Tape sintering shrinkage was found to be 16.7%, 20.1%, and 26.3% for tapes sintered at 1250° C., 1350° C., and 1400° C., respectively. The discs of dried tape were out-gassed and then pre-sintered at 1000° C., followed by a sintering and ironing step at either 1250° C., 1350° C., or 1400° C. Ironing the substrates under load at the sintering temperature made the substrates flat to facilitate plasma spraying.

YSZ layers were plasma sprayed onto the substrates using an Axial III™ torch (available from Northwest Mettech Corp. of North Vancouver, Canada) mounted on a 2 axis robot. The NiO-YSZ substrates were mounted on a 300 mm diameter drum. The sample holder allowed for a 0.5 inch diameter disc area to be sprayed through a mask in front of the substrate. 5 μm to 25 μm fused and crushed feedstock powders (Sulzer Metco, Seattle, USA) were fed through a vibrating hopper (CPF-2HP, 11.5 cm inner diameter, vibration on maximum) feeding the powder at a constant rate into a constant carrier gas flow under the plasma spraying conditions set out in Table 2.

TABLE 2
Plasma-spraying Conditions

| Parameter [unit] | Value |
|---|---|
| Plasma gas composition [%] | N₂ [100%] |
| Plasma gas flow rate [slpm] | 200 |
| Carrier gas composition [%] | Ar 100% |
| Carrier gas flow rate [slpm] | 15 |
| Standoff distance [mm] | 130 |
| APS torch electrodes | 3 |
| Power per electrode [kW] | 50 |
| Torch current per electrode [A] | 250 |

A sol was prepared by mixing the materials listed in column #1 of Table 3. After adding each material, the solution was stirred at 200 rpm for 30 minutes without heating. After all materials were added, the solution was stirred for 12 hours. A discussion of making sols is provided in M. Keshmiri, O. Kesler, Acta Materialia, 54 (2006) 4149-4157, which is hereby incorporated herein by reference.

TABLE 3
Sol gel components (by weight [g])

| | Sample No. | | |
|---|---|---|---|
| | (#1 - medium | | |
| | concentration; | | |
| | #2 - lower concentration; | | |
| | #3 - higher concentration) | | |
| Chemical | #1 | #2 | #3 |
| 2 propanol (Sigma Aldrich) | 50 | 50 | 50 |
| Acetyl acetone (Sigma Aldrich) | 2.5 | 2.5 | 2.5 |
| Zirconium tetrapropoxide (Sigma Aldrich) | 8 | 4 | 16 |
| Distilled water | 5 | 2.5 | 10 |
| Yttrium nitrate hexahydride (Sigma Aldrich, | 1.68 | 0.84 | 3.36 |
| 99.9%) | | | |

The resulting sol is an organic-based YSZ sol. The primary particle size in the sol was on the order of 200 nm. However, these particles may tend to clump into large aggregates having sizes on the order of 60 μm. It is generally desirable that the particles in the sol be smaller than the openings of pores in the ceramic layer so that the particles can enter and seal the pores. It is generally desirable that the particles have substantially the same material composition as the ceramic layer.

Preferably, the solid powder loading of a composite sol (i.e. a sol that will produce a layer having a given chemical composition that has suspended in it particles having a chemical composition the same as that of the layer) does not exceed about 1-2 wt %. Higher solid loading can tend to produce cracked layers during spin coating and drying.

Spin coating was performed using a model WS-400B-6NPP/Lite/10K spin coater (available from Laurell Technologies Corporation of North Wales, Pa.) on the plasma sprayed YSZ layers. The substrates were spun at 3000 rpm for 2 minutes. While the substrates were spinning, 1000 μl of sol was pipetted onto the substrate in ten 100 μl volumes of sol. One 100 μl volume of sol was delivered every five seconds using a pipette. The samples were then transferred to a hot plate set to 300° C. This procedure was repeated to achieve multiple layer coatings.

After spin-coating with one or more layers of sol, the samples were heated to 500° C. or 650° C. for one hour. FIG. 1A shows high-temperature X-ray diffraction data for the sol gel. YSZ peaks in the X-ray diffraction pattern indicate that a cubic YSZ phase has formed by 500° C. Further YSZ crystallite growth continues up to 1000° C. This result suggests that a firing temperature of less than 900° C. (such as 650° C. or even 500° C.). is sufficient to cause the materials in the sol to react to form a cubic YSZ phase. Higher temperature sintering steps that could accelerate oxidation of metallic interconnects or lead to undesired inter-reactions between fuel cell layers are not required. Since firing of the sol-coated layers can be performed at temperatures that do not exceed typical SOFC operating temperatures, firing may optionally be performed in-situ prior to fuel cell operation, thus eliminating the need for an additional separate processing step.

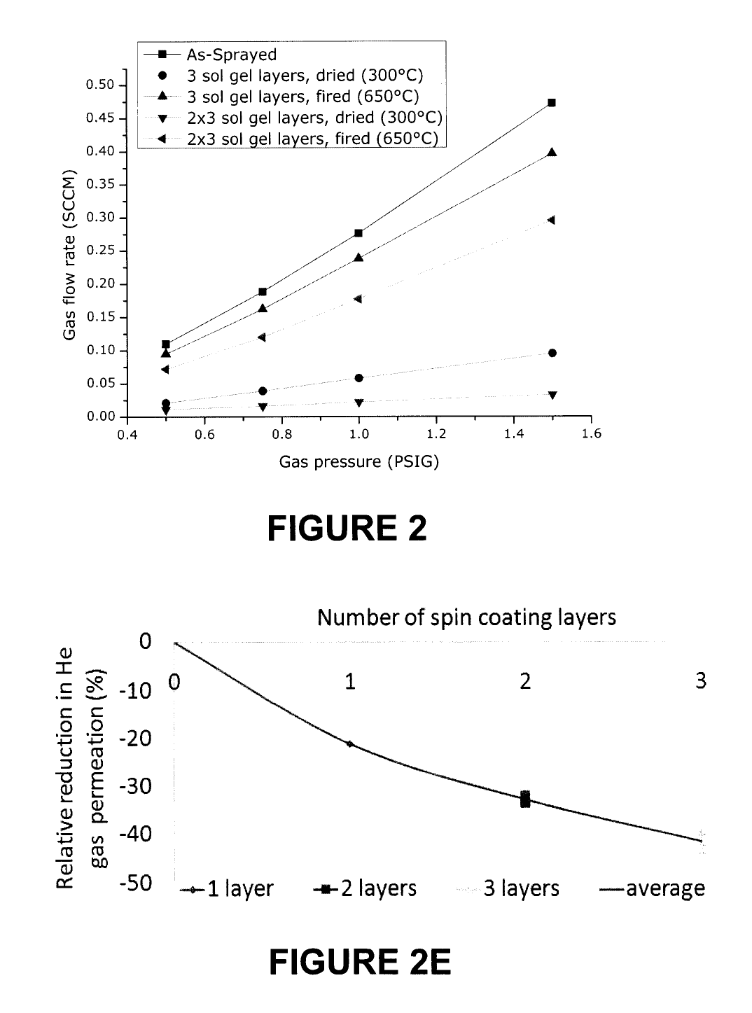

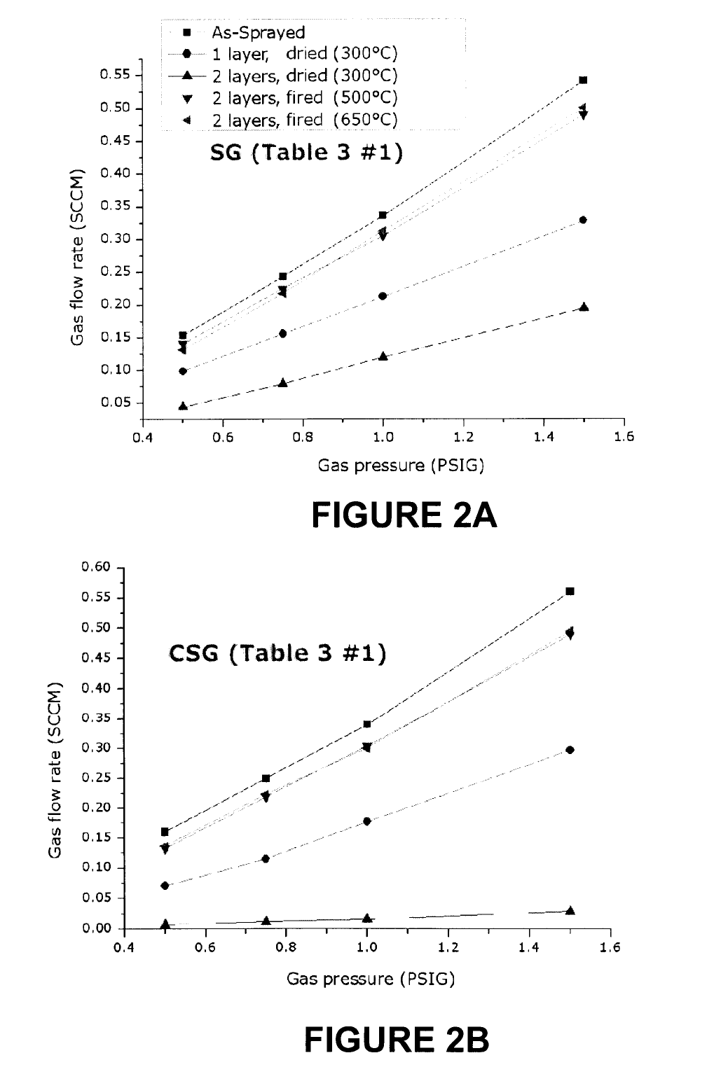

FIG. 2 shows the permeability of the samples to helium gas as a function of gas pressure. It can be seen that the application of spin-coated sol-gel layers results in a beneficial reduction in gas permeability.

The concentration of the sol can be varied. The optimum sol concentration will depend to some degree on the porosity of the ceramic layer and the sizes of the pores in the ceramic layer. The demonstration embodiment used a sol having the material composition set out in column #1 of Table 3. Sols having greater concentration and lower concentrations, as set out in column #3 and #2 of Table 3 respectively, were used in comparison studies. FIGS. 2A, 2B, 2C and 2D show respectively the effects on gas permeability of spin-coating with:
a sol having the material composition of column #1 of Table 3,
a sol having the material composition of column #1 of Table 3 with the addition of 1% by weight of YSZ powder;
a sol having the composition of column #2 of Table 3; and,
a sol having the composition of column #2 of Table 3 with the addition of 1% by weight of YSZ powder.

The composite slurries which included YSZ powder were sonicated for several hours in a water bath at room temperature prior to use to break down agglomerates. The data points in FIGS. 2A to 2D have shapes that correspond to the key that is included in FIG. 2A. FIG. 2E shows the effect of applying different numbers of layers of spin-coated sol-gel layers on helium gas permeability. It can be seen that the reduction in gas permeability resulting from the addition of different numbers of coating layers is significant and much larger than the amount of variability from one specimen to the next within the same set of conditions. For FIG. 2E, three cells were produced for each set of conditions tested.

Further improvements (i.e. reductions) in gas permeability may be achieved by one or more of:
using hotter plasma deposition conditions (e.g. by using a higher-energy plasma or a plasma having a higher thermal conductivity) to obtain plasma-sprayed layers that are initially less porous. A higher-energy plasma can be obtained, for example, by using a plasma gas that includes helium or hydrogen.
applying the plasma-sprayed layers to a surface having a fine microstructure. This may be achieved, for example, by providing a layer having a fine microstructure on top of a coarser and more porous substrate. Such a layer may be applied by screen printing, wet ceramic processing techniques, plasma spraying, or other thermal spraying techniques. The layer may comprise a powder having a small particle size, for example. The fine microstructure layer may comprise a functional anode layer, for example.
optimizing the concentration and/or composition of the sol.
adding additional ceramic-grade particles to the sol deposited by spin coating. These additional particles may have the same or similar composition as the ceramic layer. For example, where the ceramic layer comprises YSZ, the additional particles may comprise particles of YSZ.
producing layers having compositional gradients. This may be achieved, for example, by changing the composition of the powder feeding a thermal spray torch (such as a plasma-spraying torch) as deposition progresses.
applying multiple layers by plasma spraying or another thermal spraying process.
impregnating the substrates with a sol or composite sol by vacuum impregnation or another suitable impregnation process.

The inventors have determined that the application of spin-coated layers to a ceramic layer can improve the properties of the layers for use in fuel cells apart from any benefit obtained by sealing. It is thought that this improvement may result from a change in the surface morphology of the ceramic layer. Where the ceramic layer is used as a fuel cell electrolyte, it has been found that the application of spin-coated layers tends to reduce the polarization resistance of the fuel cell.

The electrochemical characteristics of a device including a ceramic or cermet layer (such as a YSZ layer) may be improved by a process comprising applying to the ceramic or cermet material one or more layers of a sol having a material composition that is the same as or similar to that of the ceramic or cermet material by spin-coating and then heat treating the spin-coated ceramic or cermet layer. This method may be applied to improve the electrochemical properties of an interface between the ceramic or cermet layer and another layer. For example, the method may be applied to improve electrochemical properties of an interface between a ceramic layer and an electrode layer (which could, for example, comprise a Sm_{0.5}Sr_{0.5}CoO_{3-y} (SSC)/Sm_{0.2}Ce_{0.8}O_{3-y} SDC layer). The ceramic layer may comprise a layer of YSZ or another suitable ceramic. The ceramic layer may be formed by plasma-spraying, or another thermal spraying process, but this is not mandatory.

### EXAMPLE 2

Simple solid oxide fuel cells incorporating plasma-sprayed and spin-coated

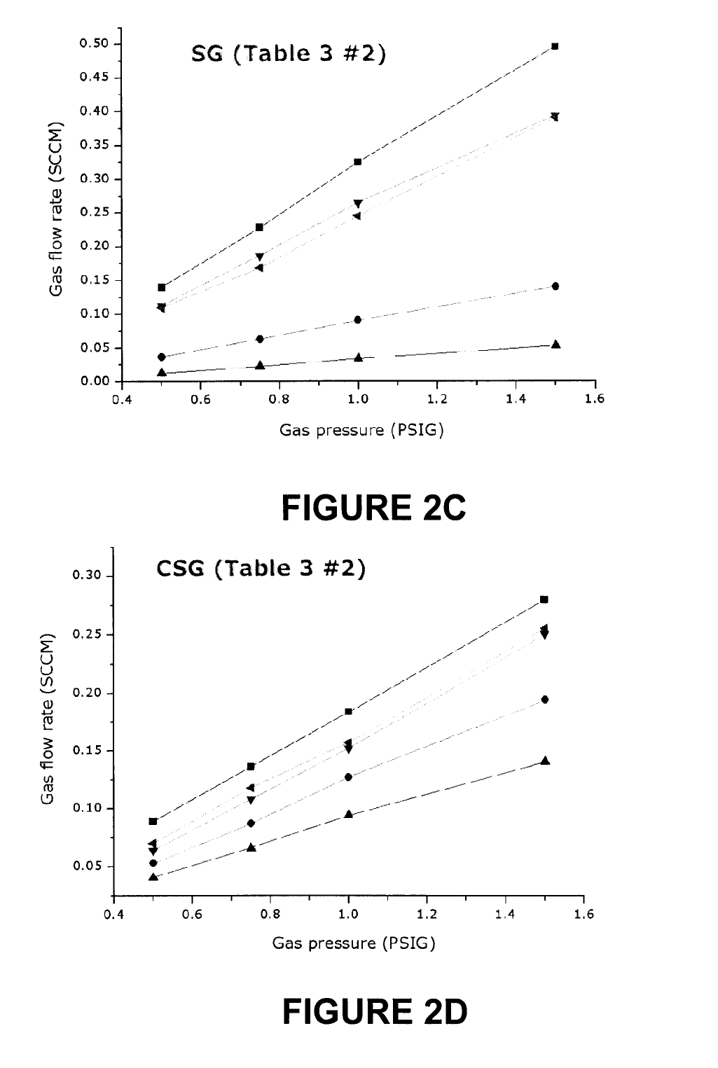

YSZ electrolytes (made as described in Example 1 above) were made by applying cathode slurries to the electrolytes. The cells had the structure shown in cross-section in FIG. 3. FIG. 3 shows a cell 40 comprising an anode substrate 42, an electrolyte layer 44 on the substrate, a cathode layer 46 on the electrolyte layer, and a layer of sealant 48 surrounding the electrolyte layer.

The cells were fabricated by applying composite Sm_{0.5}Sr_{0.5}CoO_{3-y} (SSC)/Sm_{0.2}Ce_{0.8}O_{3-y} (SDC) 40/60wt % cathode slurries to the YSZ electrolytes through a 0.96 cm opening in a polymer mask using a spatula. The cathode was sintered at 900° C. for 4 hours. The parts of the cathode-side surface of each cell not covered by plasma-sprayed electrolyte were sealed with YSZ-thermally matched Ceramabond™ (Aremco) and dried for 1 hour at room temperature, then heated in air for 2 hours at 92° C., 2 hours at 200° C., and 2 hours at 500° C. The cell was then heated to its testing temperature.

Open circuit potential measurements and full cell polarization and impedance tests were performed at 800° C., 750° C., and 700° C., using a Solartron 1260 Frequency Response Analyzer coupled with a Solartron 1470E Multistat (London Scientific, Canada). The impedance response of the system was recorded from 0.1 Hz to 10 kHz.

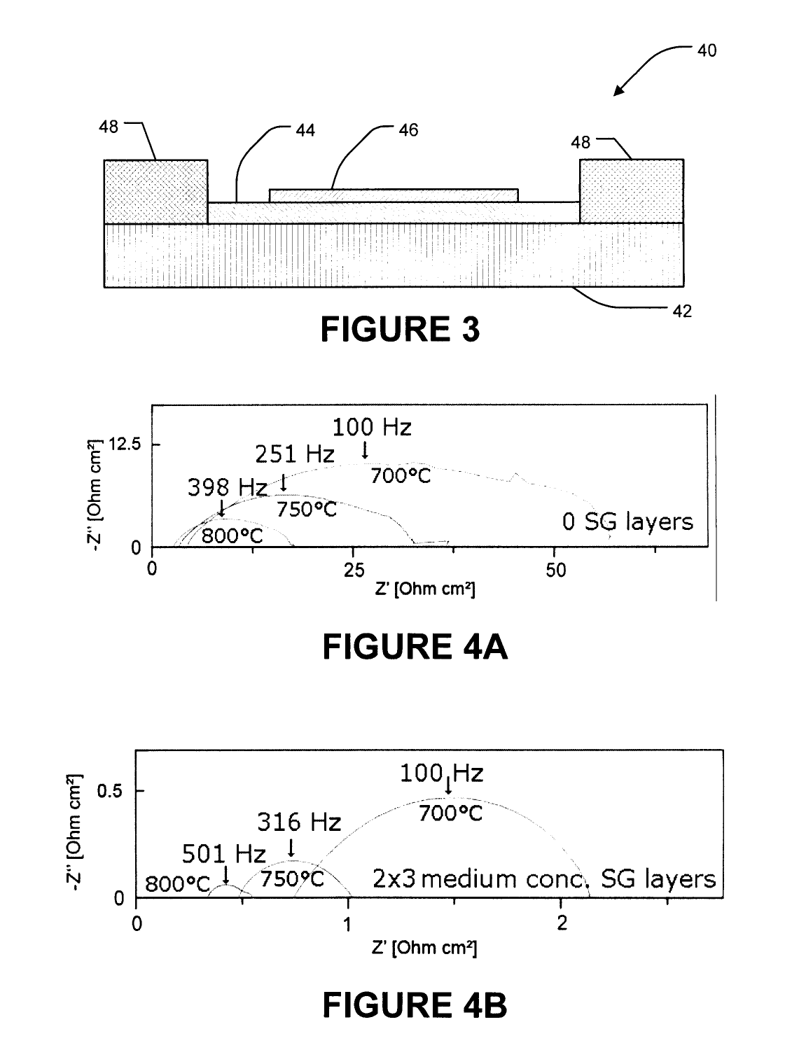

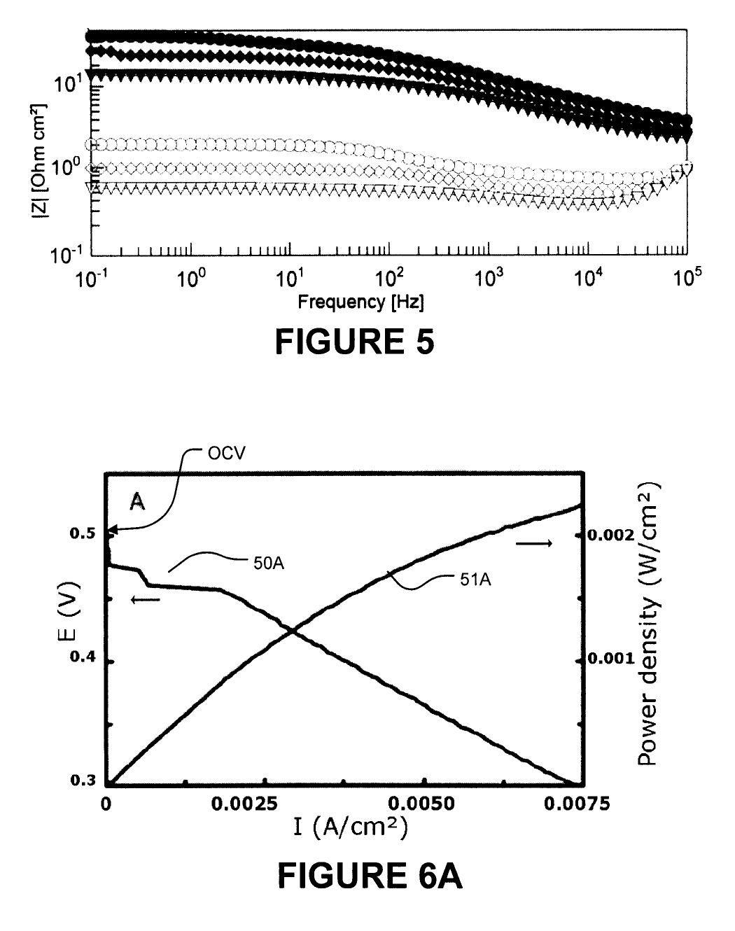

The improvement in electrochemical performance resulting from the application of the spin-coated sol layers can be seen in the electrochemical impedance spectra and polarization curves shown in FIGS. 4A to 7. FIG. 4A shows electrochemical impedance spectra of a cell without sol layers. FIG. 4B shows electrochemical impedance spectra of a cell made by applying 6 medium concentration sol coating layers with 2 firing steps. FIG. 5 shows the magnitudes of the impedances of the two cells as a function of frequency for 3 different temperatures: 700° C., 750° C., and 800° C.

From FIGS. 4A and 4B it can be seen that there is a difference in excess of one order of magnitude between the polarization resistances of the cells. From FIG. 5 it can be seen that the as-sprayed cell (solid symbols) exhibits a higher impedance than the sol-coated cell (open symbols) at all frequencies. The sol-impregnated cell (FIG. 4B and lower set of curves in FIG. 5) exhibits total cell resistance values of 0.56Ωcm², 1.06 Ωcm², and 2.20 Ωcm², while the as-plasma-sprayed cell (FIG. 4A and upper set of curves in FIG. 5) has total cell resistance values of 18.1 Ωcm², 38.7 Ωcm², and 59.8 Ωcm² at 800° C., 750° C., and 700° C. respectively.

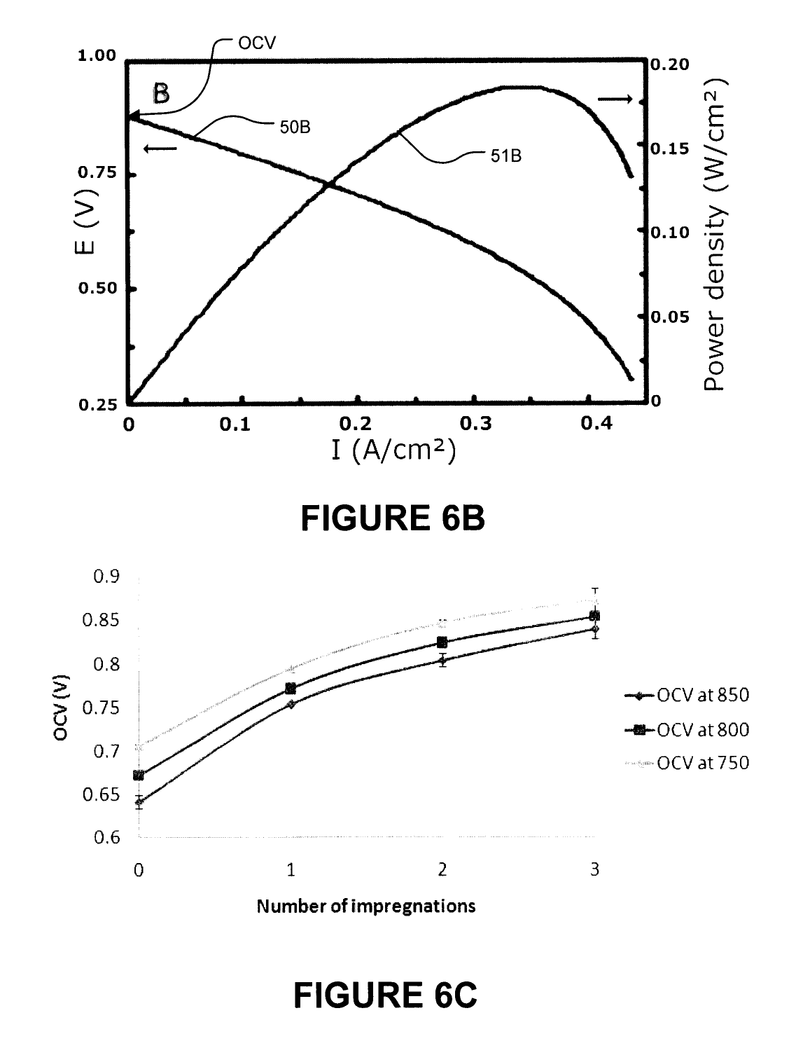

FIG. 6A includes a curve 50A which plots voltage as a function of current density for the cell without sol layers. FIG. 6B includes a curve 50B which plots voltage as a function of current density for the cell with sol coating layers. The open-circuit voltage (OCV) of the cells is independent of surface reactions, diffusion, and internal electrical resistance, and thus gives a direct measure of how well the cells isolate cathode-side and anode-side reactant gases from one another. A comparison of FIGS. 6A and 6B shows a difference in OCV between the as-plasma-sprayed cells and the cells impregnated with six coatings of medium concentration sol and fired after each third coating layer of approximately 0.36V, which correlates to a gas permeation difference of 0.279 sccm (standard cubic centimetres per minute) at 1 psig (pounds per square inch gauge), a reduction in gas permeation approximately equivalent to 60% of the as-sprayed permeation rate.

The sol gel impregnated cell has an OCV approximately 0.1V less than the theoretical OCV, while the as-plasma-sprayed cell has an OCV 0.46V less than the theoretical OCV at 800° C.

FIGS. 6A and 6B also include curves 51A and 51B showing power density as a function of current density for the as-plasma-sprayed and sol-gel-impregnated cells respectively. The as-sprayed cell, with a permeation rate of 0.332 sccm at 1 psig, exhibited a maximum power density of only 2.2 mW/cm², with an OCV of 0.520 V at 800° C.

FIG. 6C shows open-circuit voltage as a function of a number of spin-coated sol-gel layers for cells operated at 750° C., 800° C. and 850° C. Three cells were produced for each set of conditions according to the methods described above. The increase in OCV obtained by adding coating layers was significant and much larger than the amount of variability from one specimen to the next within the same set of conditions.

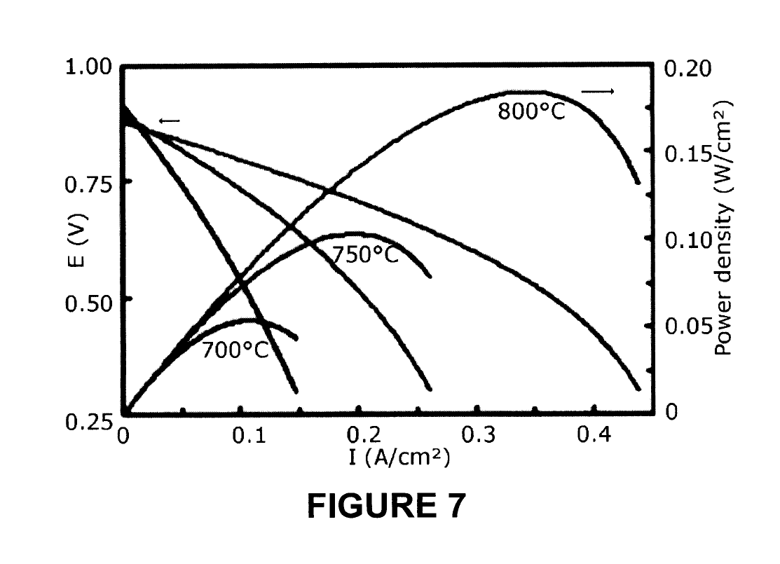

FIG. 7 includes polarization and power density curves at 800° C., 750° C., and 700° C. for the sol-impregnated cell. The cell produced a maximum power density of 180 mW/cm² at 800° C., 102 mW/cm² at 750° C., and 55 mW/cm² at 700° C. As expected, the OCV increases slightly with lower temperatures, from 0.878V at 800° C. to 0.894V at 750° C. to 0.914V at 700° C., at an absolute permeation rate of 0.177 sccm at 1 psig. The absolute values of OCV, however, are approximately 100 mV lower than the theoretical maximum values of 0.980V, 0.995 V, and 1.011 V, at 800° C., 750° C., and 700° C., respectively.

It can be appreciated that there are a wide range of parameters that may be varied to achieve desired results without departing from the invention. For example, the purity of raw materials used, particle shapes, particle sizes, and size distribution of powders used in plasma-spraying, as well as other spraying and process parameters throughout the process can affect the quality of the plasma-sprayed layer. Powders having very small particles are susceptible to vaporisation in the plasma torch and to difficulties with feeding. Powders having very large particles will not fully melt in the plasma, and particles may bounce off the substrate surface if they have remained solid or have re-solidified in-flight. The wide range of feedstocks available for plasma spraying provides the process with the flexibility that is required for the spraying of different SOFC layers that consist of different combinations of materials, with widely varying porosity requirements. This flexibility makes plasma spraying potentially more readily adaptable to the fabrication of SOFCs than other deposition processes that can utilize only one feedstock type. The plasma gas may comprise hydrogen, helium, argon, nitrogen, other suitable gases or mixtures thereof.

Plasma spraying has the potential to be applied to deposit all of the electrochemically active fuel cell layers in a solid oxide fuel cell. Plasma spraying may be used to deposit the electrodes and electrolyte layer on a relatively inexpensive metallic interconnect (IC) support layer, thus reducing the material cost of the fuel cell. The support layer may be made from any suitable metal. Nickel and appropriate stainless steels are suitable metals for some applications.

Since plasma-sprayed layers can be deposited without the necessity of lengthy high-temperature firing steps, the need for parallel production lines for mass production is also decreased. By avoiding high temperature firing steps (e.g. sintering at temperatures in excess of 950° C.) material compatibility problems such as chemical reactions between the materials of adjoining layers at high firing temperatures can be avoided. Oxidation of metallic substrates can also be minimized or avoided by avoiding high-temperature firing steps. The reduction in process steps, processing time, and firing temperatures can reduce production cost, labor intensity and energy usage. Such processes can therefore be both economically and ecologically favorable (e.g. reduced ecological footprint) in comparison to prior processes that are more labor- and energy-intensive.

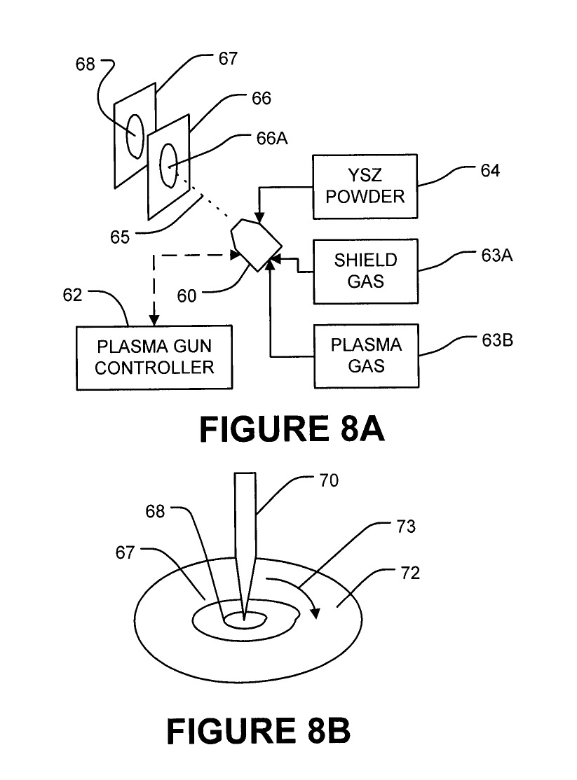

FIGS. 8A and 8B illustrate one method for making a fuel cell. FIG. 8A shows a plasma gun 60 controlled by a plasma gun controller/power supply 62. Plasma gun 60 is supplied with shield or shroud gas 63A, plasma gas (or “carrier” gas) 63B and YSZ powder 64. Shroud gas 63A is not mandatory. The YSZ powder is injected into the plasma 65 and passes through an aperture 66A in a mask 66. Plasma gun 60 may be of any suitable type and construction. A range of plasma guns having characteristics that are suitable for use in plasma spraying ceramic powders, for example, YSZ powders, are commercially available from various suppliers including Northwest Mettech Corp. of North Vancouver, Canada. The powdered ceramic may be injected into the plasma radially or axially, for example. The particles of ceramic material melt in the plasma and adhere onto a substrate 67 to provide an electrolyte layer 68. Substrate 67 comprises a metallic interconnect in this example embodiment. The substrate comprises an anode layer or a cathode layer on the metallic interconnect such that electrolyte layer 68 is deposited onto the anode layer or cathode layer. The metallic interconnect (and anode or cathode layer) may have been deposited by plasma spraying in one or more earlier steps. A second electrode layer (cathode or anode layer) may then be deposited (with or without one or more additional layers) on electrolyte layer 68.

In FIG. 8B, substrate 67 has been placed on the rotating stage 72 of a spin-coating machine and is being rotated as indicated by arrow 73. A dispenser, such as a pipette, 70 deposits a sol onto the surface of electrolyte layer 68. This may be repeated. The substrate is then fired, either before or after being incorporated into a fuel cell.

Where a component (e.g. a substrate, plasma spray torch, assembly, anode, electrolyte etc.) is referred to above, unless otherwise indicated, reference to that component (including a reference to a “means”) should be interpreted as including as equivalents of that component any component which performs the function of the described component (i.e., that is functionally equivalent), including components which are not structurally equivalent to the disclosed structure which performs the function in the illustrated exemplary embodiments of the invention.

As will be apparent to those skilled in the art in the light of the foregoing disclosure, many alterations and modifications are possible in the practice of this invention without departing from the spirit or scope thereof. Accordingly, the scope of the invention is to be construed in accordance with the substance defined by the following claims.

1. A method for making a densified ceramic layer, the method comprising:
plasma spraying a layer of ceramic material onto a substrate to provide a porous ceramic layer;
applying one or more layers of a sol having a material composition similar to that of the ceramic material to the ceramic layer by spin-coating the ceramic layer with the sol and allowing the sol to infiltrate pores in the ceramic layer; and
heat treating the ceramic layer;
wherein a density of the ceramic layer is increased.

2. A method according to claim 1 wherein the sol comprises particles that are smaller than openings of the pores in the ceramic layer.

3. A method according to claim 1 wherein the plasma spraying is performed in an air atmosphere.

4. A method according to claim 1 wherein the plasma spraying is performed with the substrate at atmospheric pressure.

5. A method according to claim 1 wherein the plasma spraying is performed with the substrate at pressure that is less than atmospheric pressure.

6. A method according to claim 1 wherein the plasma spraying is performed using a plasma gas comprising helium.

7. A method according to claim 1 wherein the plasma spraying is performed using hydrogen.

8. A method according to claim 1 wherein the plasma spraying is performed using one or more of nitrogen and argon.

9. A method according to claim 1 wherein applying the one or more layers of the sol comprises spin-coating the ceramic layer with one to five coats of the sol.

10. A method according to claim 9 comprising heating the ceramic layer to a temperature of at least 100° C. between applying coats of the sol.

11. A method according to claim 1 wherein spin-coating the ceramic layer with the sol comprises applying a plurality of coats of the sol by spin coating.

12. A method according to claim 1 wherein applying the one or more layers of sol comprises applying a plurality of layers of the sol and drying the ceramic layer between applying the layers of the sol.

13. A method according to claim 12 wherein drying the ceramic layer comprises heating the ceramic layer to a temperature of at least 100° C.

14. A method according to claim 12 wherein drying the ceramic layer comprises warming the ceramic layer to a temperature of at least 50° C.

15. A method according to claim 1 wherein the ceramic layer has a porosity of at least 5% before applying the one or more layers of the sol.

16. A method according to claim 15 wherein, after the heating, a surface of the ceramic layer is essentially free of any morphologically-distinct layer of the sol.

17. A method according to claim 1 comprising allowing the sol to react to form a ceramic during the heat treating.

18. A method according to claim 17 wherein the ceramic formed by heating the sol has a composition essentially the same as that of the ceramic layer.

19. A method according to to claim 1 wherein the sol has a material composition essentially the same as that of the ceramic layer.

20. A method according to claim 19 wherein the sol comprises particles of the ceramic.

21. A method according to claim 1 wherein the ceramic layer constitutes at least a part of a fuel cell electrolyte and heating the ceramic layer is performed while the ceramic layer is in situ in a fuel cell.

22. A method according to claim 1 wherein the sol comprises particles having diameters on the order of 1 μm or less.

23. A method according to claim 1 wherein the sol comprises particles characterized by an average diameter on the order of 1 μm or less.

24. A method according to claim 1 wherein the sol has a solid loading not exceeding 2 wt %.

25. A method according to claim 24 wherein the sol has a solid loading not exceeding 1.5 wt %.

26. A method according to claim 1 wherein the sol comprises zirconium ions.

27. A method according to claim 1 wherein the sol comprises zirconium in the form of zirconium tetrapropoxide.

28. A method according to claim 1 wherein the sol comprises yttrium ions.

29. A method according to claim 1 wherein the sol comprises yttrium in the form of yttrium nitrate.

30. A method according to claim 1 wherein the sol comprises particles of yttria-stabilized zirconia (YSZ).

31. A method according to claim 1 wherein the ceramic comprises yttria-stabilized zirconia (YSZ).

32. A method according to claim 1 wherein the ceramic is selected from the group consisting of: alumina-stabilized zirconia;
calcia-stabilized zirconia; magnesia-stabilized zirconia;
scandia-stabilized zirconia; samaria-doped ceria;
gadolinia-doped ceria; and lanthanum strontium gallium magnesium oxide.

33. A method according to claim 1 wherein the ceramic comprises ceria doped with a rare-earth element.

34. A method according to claim 33 wherein the rare earth element is selected from the group consisting of: Y, La, Pr, Nd, and Pm.

35. A method according to claim 1 wherein the ceramic comprises a stabilized zirconia.

36. A method according to claim 1 wherein the sol has a concentration given by a weight ratio of dry ingredients to solvent in the range of 10:100 to 40:100.

37. A method according to claim 1 wherein the sol is an organic-based sol.

38. A method according to claim 1 wherein the sol is an inorganic-based sol.

39. A method according to claim 1 wherein the sol is a water-based sol.

40. A method according to claim 1 wherein heat treating the ceramic layer is performed at a temperature not exceeding 800° C.

41. A method according to claim 41 wherein heat treating the ceramic layer is performed at a temperature not exceeding 750° C.

42. A method according to claim 41 wherein heat treating the ceramic layer is performed at a temperature not exceeding 700° C.

43. A method according to claim 40 wherein heat treating the ceramic layer is performed at a temperature of at least 300° C.

44. A method according to claim 40 wherein heat treating the ceramic layer is performed at a temperature of at least 500° C.

45. A method according to claim 1 wherein, after the heating, a morphologically-distinct layer is present on the ceramic layer.

46. A method according to claim 1 wherein the substrate is planar.

47. A fuel cell comprising an electrolyte layer made according to a method according to claim 1.

48. A fuel cell electrolyte structure made according to a method according to claim 1.

49. A thermal barrier structure comprising a densified ceramic layer made according to the method of claim 1.
